(19) United States
(12) Patent Application Publication
(10) Pub. No.: US 2012/0062415 A1
(43) Pub. Date: Mar. 15, 2012

(54) LOCATION INFORMATION DECISION METHOD IN INTEGRATED TERMINAL

(75) Inventors: Hyungu HWANG, Daejeon (KR); Hee Sang CHUNG, Daejeon (KR)

(73) Assignee: Electronics and Telecommunications Research Institute, Daejeon (KR)

(21) Appl. No.: 13/020,163

(22) Filed: Feb. 3, 2011

(30) Foreign Application Priority Data
Sep. 13, 2010 (KR) 10-2010-0089616

(51) Int. Cl. G01S 19/46

(52) U.S. Cl. 342/357.29

(57) ABSTRACT

Provided is a method of efficiently determining a location of a terminal. The method includes receiving both of a GPS signal and a mobile communication signal. When the GPS signal is not received, a location calculated using the mobile communication signal is determined as the location of the terminal.

### CROSS-REFERENCE TO RELATED APPLICATIONS

This U.S. non-provisional patent application claims priority under 35 U.S.C. §119 from Korean Patent Application No. 10-2010-0089616, filed on Sep. 13, 2010, the entire contents of which are hereby incorporated by reference.

### BACKGROUND OF THE INVENTION

The present invention disclosed herein relates to obtaining or deciding location information, and more particularly, to a location information decision method for use in an integrated terminal.

Various types of communication systems have been developed with advancements of information and communication technology. However, the communication systems are operated independently without linkage between them. For instance, a communication system such as a navigation device performs an operation for finding its location using information of a GPS receiver, and a communication system such as a cell phone just performs wireless communication with a base station. That is, the two communication systems are operated independently without linkage between them.

However, in the case that such an integrated terminal illustrated in FIG. 1 is widely disseminated, interconnections among various communication systems may be performed for efficiently providing services.

Herein, the integrated terminal typically finds its location based on a GPS modem. However, in the case that the integrated terminal is positioned at a shadow area such as a basement, it may be difficult to decide location information or obtained location information may be incorrect.

### SUMMARY OF THE INVENTION

The present invention provides a method of more correctly determining location information of an integrated terminal using additional information.

The present invention also provides an integrated terminal capable of more efficiently determining location information of the terminal using additional information obtained through communications with various communication systems and a method of determining the location information of the same.

The present invention also provides an integrated terminal capable of finding a current location using additional information without a GPS modem and a method of determining location information of the same.

The present invention also provides an integrated terminal capable of efficiently finding a current location by complementarily operating with a GPS modem and a method of determining location information of the same.

The present invention also provides an integrated terminal capable of correcting and determining a current location of the terminal based on information obtained through two-way communication with various communication systems and a method of determining location information of the same.

Embodiments of the present invention provide methods for obtaining location information of a terminal including obtaining location information of a wireless LAN, broadcasting the location information of the wireless LAN based on the obtained information, and obtaining the location information broadcasted from the wireless LAN as the location information of the terminal.

In other embodiments of the present invention, methods for determining location information of a terminal provided with a modem block for receiving a GPS signal and a mobile communication signal include setting the modem block to receive the GPS signal and the mobile communication signal, checking whether the GPS signal is received, determining a location of the terminal based on the GPS signal in the case that the GPS signal is received, and determining a location calculated using the mobile communication signal as the location of the terminal in the case that the GPS signal is not received.

In some embodiments, detecting a time point when the GPS signal is blocked for correcting the location information of the terminal, calculating an error of the location calculated using the mobile communication signal based on a location calculated using a lastly received GPS signal, and correcting the location calculated using the mobile communication signal as much as the calculated error in a GPS signal shadow area may be further included.

In other embodiments, storing a location where the GPS signal is lastly received for a non-periodic trial for receiving the GPS signal, and trying to receive the GPS signal when the location calculated using the mobile communication signal approaches the stored location may be further included.

In still other embodiments, not-performing a reception trial may be further included for reducing power consumption when the calculated location is not in an area where a desired signal is receivable.

In even other embodiments, determining whether the current location of the terminal is in an area where the GPS signal is receivable using location information of the terminal and a map data non-obtainable from the GPS modem block when the GPS signal is not received by the GPS modem block, and controlling the GPS modem block not to try to receive the GPS signal in the case that the current location of the terminal is not in the area where the GPS signal is receivable may be further included.

In still other embodiments of the present invention, integrated terminals include a first communication modem for receiving a GPS signal, a second communication modem for receiving a mobile communication signal by communicating with a mobile communication system, and a location determining unit connected to the first and second communication modems for determining location information of the integrated terminal based on the GPS signal when the GPS signal is received through the first communication modem and determining the location information of the integrated terminal based on the mobile communication signal received through the second communication modem when the GPS signal is not received.

In some embodiments, the first and second communication modems may be integrated into one terminal, and the location information determining unit may include a microprocessor for processing internal programs.

In other embodiments, the location determining unit may perform capturing a time point when the GPS signal is blocked for correcting the location information of the terminal, calculating an error of the location calculated using the mobile communication signal based on a location calculated using a lastly received GPS signal, and correcting the location calculated using the mobile communication signal as much as the calculated error in a GPS signal shadow area.

In still other embodiments, the location determining unit may perform storing a location where the GPS signal is lastly received for a non-periodic trial for receiving the GPS signal and trying to receive the GPS signal when the location calculated using the mobile communication signal approaches the stored location.

In even other embodiments, the location determining unit may perform obtaining additional location information of the terminal in the case of controlling retrial for receiving the GPS signal, checking whether the terminal is in an area where the GPS signal is receivable using location of the obtained information, and blocking the reception trial for reducing power consumption of the terminal in the case that the terminal is not in the area where the GPS signal is receivable.

In yet other embodiments, the additional location information may include at least one of location information of the terminal and a map data.

In even other embodiments of the present invention, integrated terminals include a modem block including a first communication modem for receiving a GPS signal, a second communication modem for receiving a mobile communication signal by communicating with a mobile communication system, and a third communication modem for receiving traffic information provided by ITS, and an operation control unit connected to the first to third communication modems of the modem block for determining location information of the integrated terminal based on the GPS signal when the GPS signal is received through the first communication modem and determining the location information of the integrated terminal based on the mobile communication signal received through the second communication modem when the GPS signal is not received.

In some embodiments, the first and second communication modems and the operation control unit may be installed in one integrated terminal.

In other embodiments, the operation control unit may include a microprocessor for processing internal programs.

In still other embodiments, the operation control unit may perform detecting a time point when the GPS signal is blocked for correcting the location information of the terminal, calculating an error of the location calculated using the mobile communication signal based on a location calculated using a lastly received GPS signal, and correcting the location calculated using the mobile communication signal as much as the calculated error in a GPS signal shadow area.

In even other embodiments, the operation control unit may perform storing a location where the GPS signal is lastly received for a non-periodic trial for receiving the GPS signal and trying to receive the GPS signal when the location calculated using the mobile communication signal approaches the stored location.

In yet other embodiments, the operation control unit may perform obtaining additional location information of the terminal in the case of controlling retrial for receiving the GPS signal, checking whether the integrated terminal is in an area where the GPS signal is receivable using location of the obtained information, and blocking the reception trial for reducing power consumption of the integrated terminal in the case that the terminal is not in the area where the GPS signal is receivable.

In further embodiments, the operation control unit may include at least one of location information of the integrated terminal and a map data.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating an integrated terminal applied to the present invention;

FIG. 2 is a schematic block diagram illustrating an integrated terminal using one-way information according to a conventional technology;

FIG. 3 is a schematic block diagram illustrating an integrated terminal using two-way information according to an embodiment of the present invention; and

FIG. 4 is a flowchart illustrating a control process of the location information decision in the integrated terminal of FIG. 3.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the specification, when it is commented that some devices or lines are connected to a target block, the connection includes not only a direct connection but also an indirect connection through another device.

Also, like reference numerals refer to like elements throughout. In some drawings, connections between devices and lines are illustrated just for efficiently explaining technical contents, and thus, other devices or blocks may be further included.

The embodiments exemplified and described in this disclosure may include their complementary embodiments. It should be noted that typical communication processes between a mobile communication system and a mobile communication terminal are omitted so as not to obscure the present invention.

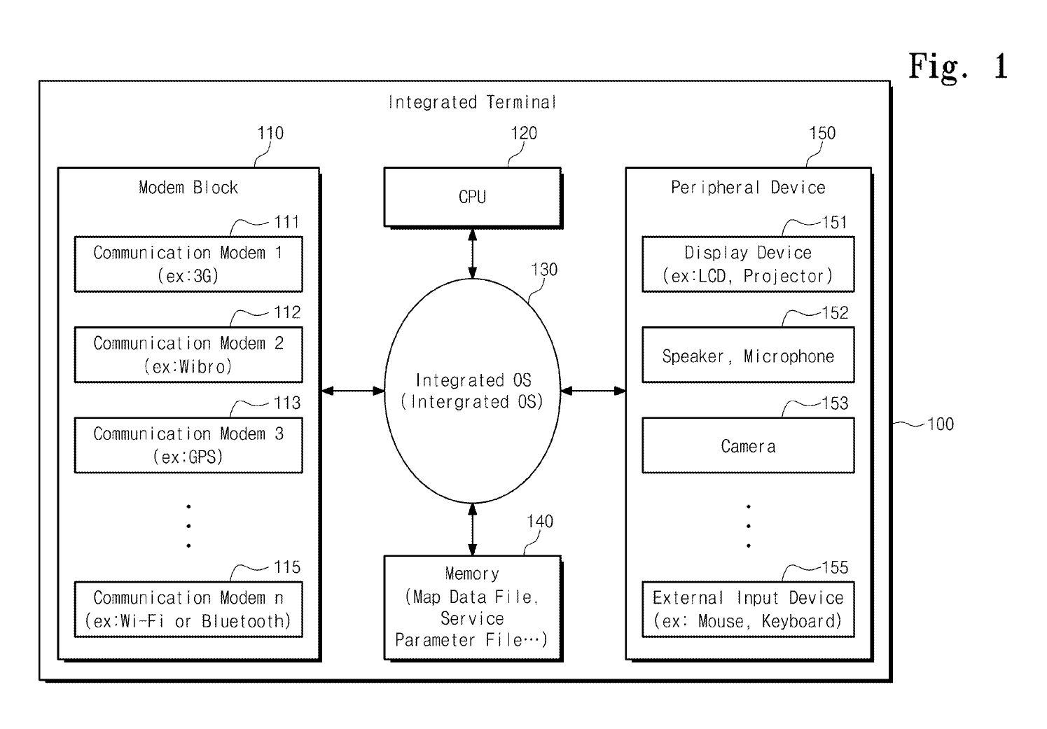

FIG. 1 is a block diagram illustrating an integrated terminal applied to the present invention. Referring to FIG. 1, an integrated terminal 100 includes a modem block 110, a Central Processing Unit (CPU) 120, an integrated Operating System (OS) 130, a memory 140, and a peripheral device 150.

For implementing functions of the integrated terminal, the modem block 110 may include a first communication modem 111 for 3 G communication, a second communication modem 112 for WiBro communication, a third communication modem 113 for GPS communication, and nth communication modem 115 for Wi-Fi or Bluetooth communication.

The CPU 120 performs various processes according to various application programs based on the integrated OS 130.

The peripheral device 150 may include a display device 151 such as an LCD or projector, speaker and microphone 152, a camera 153, and an external input device 155 such as a mouse or keyboard.

Since the integrated mobile communication terminal illustrated in FIG. 1 may be substantially implemented considering recent technology trends, it may be called the integrated terminal in the specification.

As a result, the integrated terminal where communication functions such as Bluetooth, Wi-Fi, WiBro, 3G-LTE, and GPS are integrated may be a recently well-known smart phone. Various smart phones spotlighted in a recent cell phone market include various functions supporting from MP3 and Internet to virtual reality and social network. For instance, the smart phone may be a smart phone called HD2, Omnia2 (SKT), Layla (KT), or Oz-Omnia (LGT) adopting Windows-based OS, or a smart phone called iPhone, Galaxy S, Galaxy A, Sirius Alpha, Motoglam, X10, MOTO QRTY, Optimus Z, Sirius, Motoroi, Desire, Nexus One, Andro-1, Izar, or Optimus Q adopting Android-based OS.

In the case of a product such as iPhone, it accesses a 3 G communication network or Wi-Fi network. Also, since GPS is internally installed, various applications may be run. In the case of such an integrated terminal, additional information may be obtained from various communication systems or peripheral devices.

The additional information obtainable for the integrated terminal may include various kinds of information, e.g., location information using GPS, weather information, map data information, communication system information, and second information reprocessing those kinds of information. A three-dimensional map data is only used in the military presently. However, if the three-dimensional map data is commercialized, the integrated terminal may find out whether it is positioned on the ground or in the basement or whether it is positioned outside or inside of a building using the three-dimensional map data and its location information. Such additional information may be directly inputted by a user, may be secured by a certain sensor included in the integrated terminal, or may be secured from another communication network.

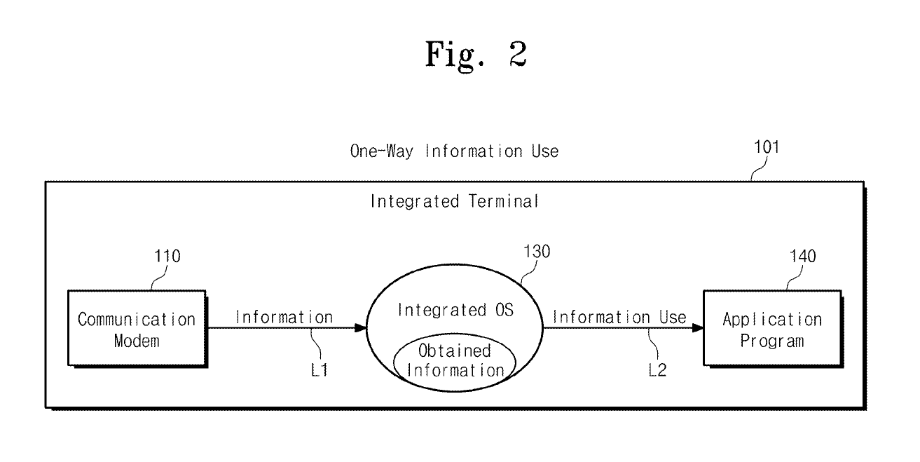

FIG. 2 is a schematic block diagram illustrating an integrated terminal using one-way information according to a conventional technology.

An integrated terminal 101 of FIG. 2 having a structure described above referring to FIG. 1 includes a communication modem 110 for receiving a GPS signal, an integrated OS 130, and an application program 140. Herein, the integrated OS 130 includes a storage unit for storing information gained from the communication modem 110 as obtained information. The integrated terminal 101 of FIG. 2 may have substantially the same structure as that of the integrated terminal 100 of FIG. 1 or may have blocks of added or reduced functions.

Referring to FIG. 2, information outputted from the communication modem 110 is applied to the integrated OS 130 through a line L1. Information outputted from the integrated OS 130 and used when the application program 140 is operated is provided through a line L2.

Such the integrated terminal of FIG. 2 which performs information use in one-way and is not linked to another communication system typically depends on only the GPS modem for determining its location. Therefore, in the case that the integrated terminal is positioned at a GPS signal shadow area, the communication modem 110 cannot receive a GPS signal, and thus, the location information decision may be difficult.

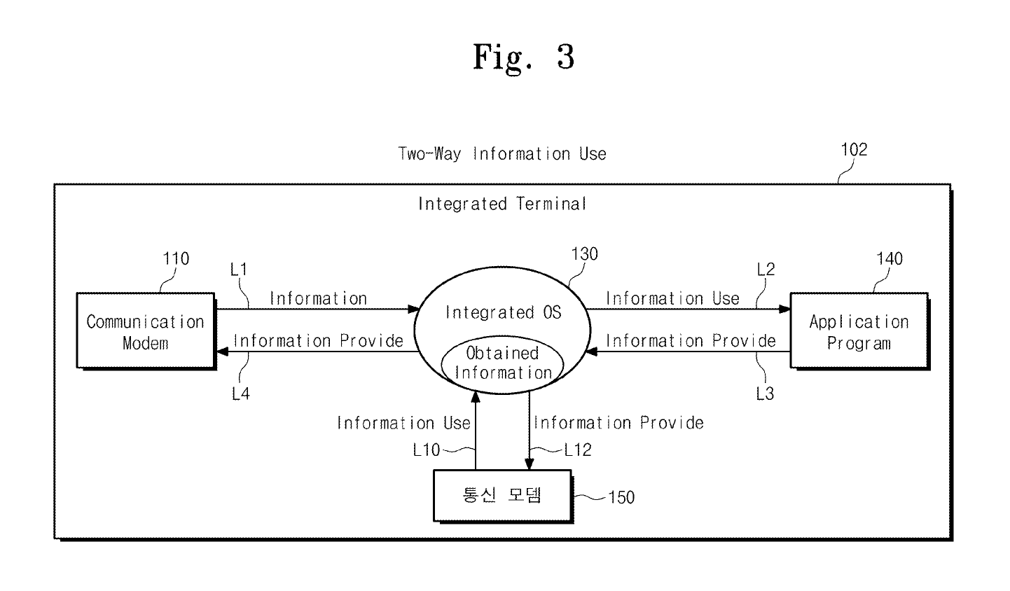

FIG. 3 is a schematic block diagram illustrating an integrated terminal using two-way information according to an embodiment of the present invention.

An integrated terminal 102 of FIG. 3 having a structure described above referring to FIG. 1 includes a communication modem 110 for receiving the GPS signal, a communication modem 150 for communicating with a mobile communication system, an integrated OS 130, and an application program 140. Herein, the integrated OS 130 includes a storage unit for storing additional information gained from the communication modems 110 and 150 as obtained information. The integrated terminal of FIG. 3 may have substantially the same structure as that of the integrated terminal 100 of FIG. 1 or may have blocks of added or reduced functions.

Referring to FIG. 3, information outputted from the communication modem 110 is applied to the integrated OS 130 through a line L1, and information outputted from the integrated OS 130 is applied to the communication modem 110 through a line L4. Also, information outputted from the integrated OS 130 is applied to the application program 140 through a line L2, and information outputted from the application program 140 is applied to the integrated OS 130 through a line L3. And, information outputted from the communication modem 150 is applied to the integrated OS 130 through a line L10, and information outputted from the integrated OS 130 is applied to the communication modem 150 through a line L12.

In the case of the integrated terminal 102 of FIG. 3 which performs information use in two-way and is linked to another communication system, even though the integrated terminal 102 is positioned at the GPS signal shadow area, the integrated terminal 102 may obtain additional information by communicating with a base station of a mobile communication system or using the communication modem 150 which performs Wi-Fi functions so that the location information decision may be more efficiently and correctly performed.

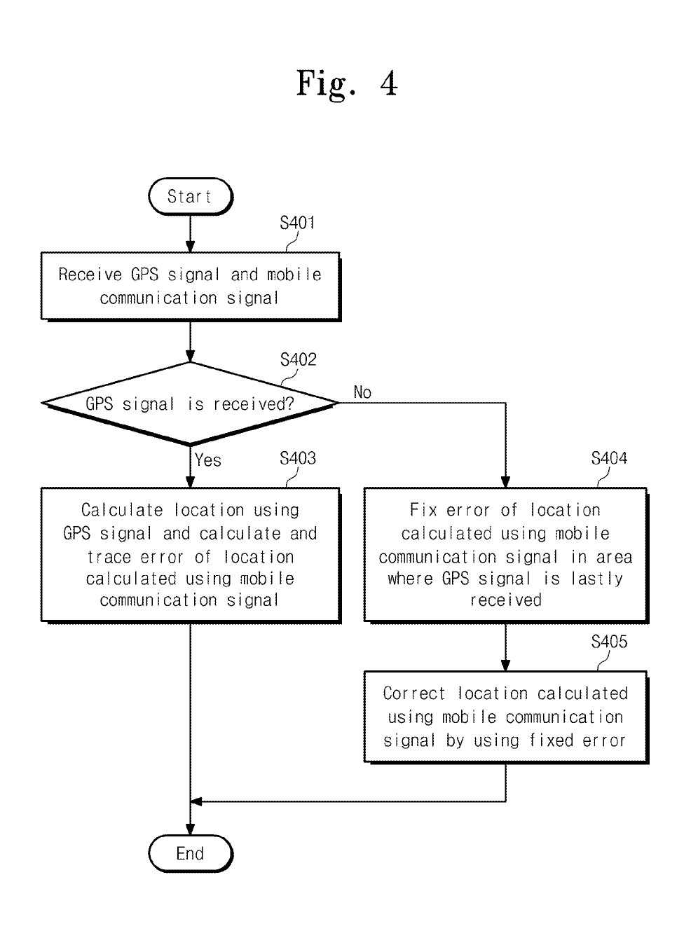

FIG. 4 is a flowchart illustrating a control process of the location information decision in the integrated terminal of FIG. 3.

Referring to FIG. 4, in operation S401, the GPS signal and a mobile communication signal are received together. Herein, the communication modems 110 and 150 are normally enabled, and the communication modems 110 and 150 receive the GPS signal and the mobile communication signal respectively. Herein, the communication modem 150 may be selected from the first communication modem 111 for 3 G communication, the second communication modem 112 for WiBro communication, and the nth communication modem 115 for Wi-Fi or Bluetooth communication of FIG. 1.

Generally, when a receiving state of the GPS signal is good, the location information of the integrated terminal may be sufficiently obtained by only the GPS signal reception. Since the GPS communication is in a good state in a car or ship, a receiving error ratio of the GPS signal is very low. However, in the mobile communication environment of the integrated terminal, the receiving error ratio of the GPS signal is relatively high. For instance, it is assumed that a user of the integrated terminal arrives at a basement garage and goes his or her office using elevator. Before the user arrives at the basement garage, the location information may be sufficiently obtained or decided using the GPS signal because the GPS communication is in a good state. However, in the basement garage or in a building, the GPS communication is obstructed so that it is difficult to normally receive the GPS signal. In this case, it is difficult to find the location of the integrated terminal and only information secured when the GPS signal is lastly received remains. Meanwhile, the communication modem 110 still tries to receive the GPS signal even when the GPS signal is blocked. If only the communication modem 110 is installed in the integrated terminal, such continuous trials require frequent operations of an RF part causing excessive battery power consumption.

According to the embodiment of the present invention, it is checked whether the GPS signal is received in operation S402 and operations are differently performed according to whether the GPS signal is received. Therefore, the power consumption is reduced and the location information obtaining or deciding is performed more simply and efficiently.

If it is detected that the GPS signal is received in operation S402, operation S403 is performed. In operation S403, the location is determined according to the GPS signal. That is, an operation of calculating the location is performed by the CPU 120 of FIG. 1 using the GPS signal. In this case, since the GPS signal may not be received suddenly, the location calculated based on the communication signal may be compared with that calculated based on the GPS signal to calculate an error, and then, an operation of tracing the error may be performed. For instance, if it is assumed that distances from the integrated terminal to base stations A, B, and C of mobile communication system calculated using the mobile communication signal are respectively about 500 m, about 700 m, and about 900 m and the distances from the integrated terminal to the base stations A, B, and C of mobile communication system calculated using the GPS signal are respectively about 450 m, about 670 m, and about 700 m, errors of the measurement are respectively about 50 m, about 30 m, and about 200 m. The calculated errors are continuously traced and fixed when the GPS signal is interrupted. In the case of the mobile communication system, the distance calculation may be performed by calculating a signal propagation time taken for the mobile communication signal to arrive at the integrated terminal from the base stations A, B, and C of mobile communication system.

Meanwhile, if it is detected that the GPS signal is not received in operation S402, operation S404 is performed. In operation S404, an operation of fixing the error of the time point when the GPS signal is interrupted is performed. That is, the measurement error is set without update when the GPS signal is not received.

Thereafter, in operation S405, an operation of correcting the current location calculated using the mobile communication signal by the fixed error is performed. As a result, in the GPS signal shadow area, the current location is calculated using the signal or information such as the mobile communication signal obtained from another communication network; however, the calculated current location is corrected as much as the traced fixed error for reducing the location error. The GPS signal shadow area may be mostly buildings or forests. Since the movement of the integrated terminal is limited in such areas, the fixed error is not greatly changed.

In the case that the communication modem 150 is a Wi-Fi modem, the integrated terminal may perform a Wi-Fi connection also in a building. If it is assumed that a Wi-Fi base station transmits its location information, the integrated terminal may determine the location of the Wi-Fi base station as its approximate current location. Generally, the communication is possible in a range of about 100 m in the case of Wi-Fi communication. However, if more precise location information is provided later, more correct location information may be obtained.

In the case that the communication modem 150 is a 3G modem, the embodiment of the present invention may be more practically applied. That is, in the GPS signal shadow area, the current location of the integrated terminal is determined using the mobile communication signal transmitted from the mobile communication system. Herein, when the location is calculated using the mobile communication signal transferred through the mobile communication network, the error is generated almost inevitably because there exist multi-paths between the base station of mobile communication system and the integrated terminal. Natural multi-paths or multi-paths due to a repeater may cause a relatively large error. Therefore, even when the GPS signal is received, this error is needed to be always traced and corrected in operation S403 as described above.

In this manner, in the GPS signal shadow area, the location calculated and corrected in the communication network is determined as the current location of the integrated terminal. In such a state, the integrated terminal may try to receive the GPS signal periodically or non-periodically.

As an example of the non-periodic reception trial, the integrated terminal may try to receive the GPS signal when the integrated terminal approaches an area where the GPS signal is lastly received. If the integrated terminal succeeds in receiving the GPS signal, the integrated terminal sets the location calculated using the GPS signal as its current location and corrects the location calculated using the mobile communication network.

If the integrated terminal may use two-dimensional or three-dimensional map data, the integrated terminal may try to receive the GPS signal when it is determined that the calculated location is out of a building. Also, in the case that it is determined that the calculated location is deep inside of a building, the GPS signal reception trial may be stopped so that the battery power consumption may be reduced. For instance, the movement of workers is limited and the GPS signal is mostly blocked in a building. Therefore, if it is determined that the integrated terminal is positioned at the GPS signal shadow area and the location is almost not changed, it reduces the battery power consumption to turn off the modem and RF part for receiving the GPS signal.

A method of receiving the GPS signal according to the embodiment of the present invention may be widely applied to all kinds of typical receivers. That is, in the case that it is determined that a receiving terminal is positioned at a place where a desired signal cannot be received, if the reception trial is stopped for a certain time, a saving of power may be optimally obtained.

As described above, in the case of using additional information obtained from two or more modems, the location information may be more efficiently obtained. Also, by using the obtained location, the receiving terminal may be more efficiently operated.

The above-described method according to the present invention may be stored as a computer-readable program into a recording medium such as CD-ROM, RAM, ROM, floppy disk, hard disk, or optical magnetic disk.

According to the embodiment of the present invention, the location of the integrated terminal can be more correctly and efficiently determined without burden to hardware.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

1. A method for obtaining location information of a terminal, comprising:
obtaining location information of a wireless Local Area Network (LAN);
broadcasting the location information of the wireless LAN based on the obtained information; and
obtaining the location information broadcasted from the wireless LAN as the location information of the terminal.

2. A method for determining location information of a terminal provided with a modem block for receiving a Global Positioning System (GPS) signal and a mobile communication signal, comprising
setting the modem block to receive the GPS signal and the mobile communication signal;
checking whether the GPS signal is received;
determining a location of the terminal based on the GPS signal in the case that the GPS signal is received;
determining a location calculated using the mobile communication signal as the location of the terminal in the case that the GPS signal is not received;
detecting a time point when the GPS signal is blocked for correcting the location information of the terminal;
calculating an error of the location calculated using the mobile communication signal based on a location calculated using a lastly received GPS signal; and
correcting the location calculated using the mobile communication signal as much as the calculated error in a GPS signal shadow area.

3. (canceled)

4. The method of claim 2, further comprising:
storing a location where the GPS signal is lastly received for a non-periodic trial for receiving the GPS signal; and
trying to receive the GPS signal when the location calculated using the mobile communication signal approaches the stored location.

5. A method for allowing an integrated terminal to try to receive a wireless signal, comprising:
allowing the integrated terminal to obtain additional location information;
determining whether the wireless signal is in an area where the wireless signal is receivable based on the obtained additional location information; and
trying to receive the wireless signal only in the area where the wireless signal is receivable according to a result of the determining.

6. The method of claim 5, wherein the wireless receiver is a GPS receiver and the wireless signal desired to be received is a GPS signal.
